(19) United States
(12) Patent Application Publication
(10) Pub. No.: US 2006/0034087 A1
(43) Pub. Date: Feb. 16, 2006

(54) End cap for illumination tube guards

(75) Inventor: Dallas Buchanan, Evanston, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: A.L.P. Lighting & Ceiling Products, Inc., Niles, IL (US)

(21) Appl. No.: 10/919,746

(22) Filed: Aug. 16, 2004

(51) Int. Cl. F21V 15/00

(52) U.S. Cl. 362/377; 362/217; 313/312

(57) ABSTRACT

An end cap for use with at least two differently diameter tube guards, wherein the two differently diameter tube guards are designed for use with a fluorescent lamp. The end cap includes a base with an aperture for accommodating electrical terminals defined on the fluorescent lamp, an internal periphery portion for frictional engagement with an external periphery of an end of one of the two differently diameter tube guards, and an external periphery portion for frictional engagement with an internal periphery of an end of the other one of the two differently diameter tube guards.

### FIELD OF THE INVENTION

The present invention relates to end caps used to hold elongated tubular lamp sleeves that are used themselves to protect incandescent and fluorescent lamps from casual impact and for retaining the lamp fragments should the fluorescent or incandescent elongate lamp brake.

### BACKGROUND OF THE INVENTION

To protect both the fluorescent lamps and the user of such lamps, elongated tubular lamp sleeves (hereinafter “tube guards”) were devised and developed many years ago, i.e. See U.S. Pat. No. 3,358,167. Along with the tube guards the prior art had to develop a method of attaching the tube guards around the fluorescent lamps and still maintain the fluorescent lamps electrical connection to the lighting fixture. As such, numerous prior art end caps have been designed and developed. For example, U.S. Pat. No. 3,358,167 includes an end cap that has an annular groove along the face of the end cap that aligns with and receives the end of the tube guards. The end cap is hollow such that the end of the fluorescent lamp may extend through the end cap and connect to the lighting fixture. See also U.S. Pat. No. 3,673,401. U.S. Pat. No. 3,808,495 is similar to the '167 patent, however, the end cap now includes beads within the annular groove such that the end of the tube guard is held more securely in place. U.S. Pat. No. 4,924,368 includes an end cap with locking teeth that align with notches placed on the end of the fluorescent lamps. U.S. Pat. No. 5,536,998 discloses an end cap that includes pads of silicone to rest against and protect the fluorescent lamps.

One major problem not dealt with or solved by the prior art is space in storage and shipping. The industry, by developing tube guards, has doubled the shipping and storage needs. Since components of the entire lighting fixture are typically bought and shipped separately from different suppliers and later assembled by the end retailer. The manufacture of the tube guards must store and stack each tube guard separately. This is mainly because for a given fluorescent lamp there is only one standard size of the tube guard. For example, Prior Art FIG. 6a, shows a standard 24 count packaging arrangement of tube guards. As shown, the tube guards are stacked on top of each other, requiring a large shipping container and high shipping charges. There is thus a need to provide improved tube guards and end caps that permit multiple sizes that will in fact reduce the space and shipping requirements.

### SUMMARY OF THE INVENTION

In accordance with the present invention, an end cap for use with at least two differently diameter tube guards, wherein the two differently diameter tube guards are designed for use with a fluorescent lamp. The end cap includes a base with an aperture for accommodating electrical terminals defined on the fluorescent lamp, an internal periphery portion for frictional engagement with an external periphery of an end of one of the two differently diameter tube guards, and an external periphery portion for frictional engagement with an internal periphery of an end of the other one of the two differently diameter tube guards. The tube guards include a first tube guard with a diameter that is such that it permits the first tube guard to slide within a second tube guard having a larger diameter.

The end cap may also include tapered internal and external periphery portions to maintain strong frictional fits with the tube guards.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of a pair of end caps in accordance with the present invention used with a tube guard that is surrounding a fluorescent bulb;

FIG. 2a is a front perspective view of an end cap from FIG 1;

FIG. 2b is a rear perspective view of the end cap from FIG. 2a;

FIG. 3 is a side view with an enlarged view of the end cap internally engaged with a small diameter tube guard;

FIG. 4 is a side view with an enlarged view of the end cap externally engaged with a large diameter tube guard;

FIG. 5 is a perspective view of the end cap engaged to a tube guard with a fluorescent bulb inside thereof;

FIG. 6a is an end view of a prior art packaging arrangement of prior art tube guards; and

FIG. 6b is an end view of a present invention packaging arrangement designed in accordance with having two differently diameter tube guards.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

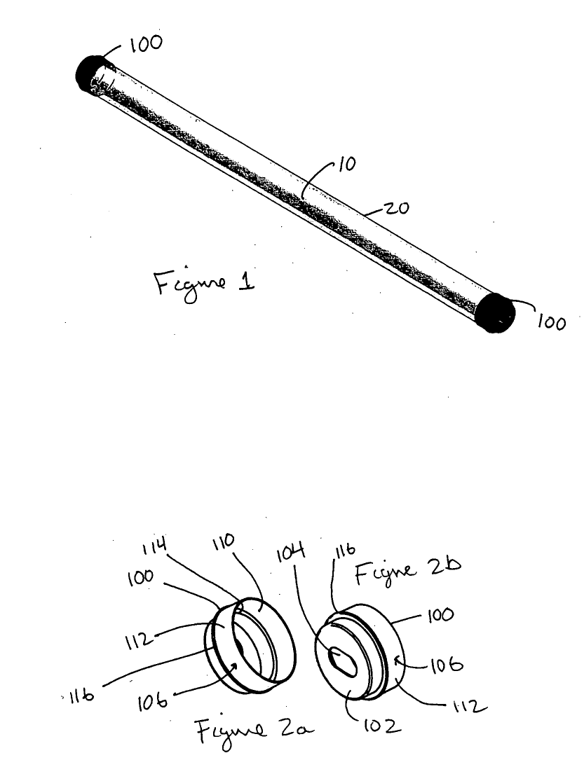

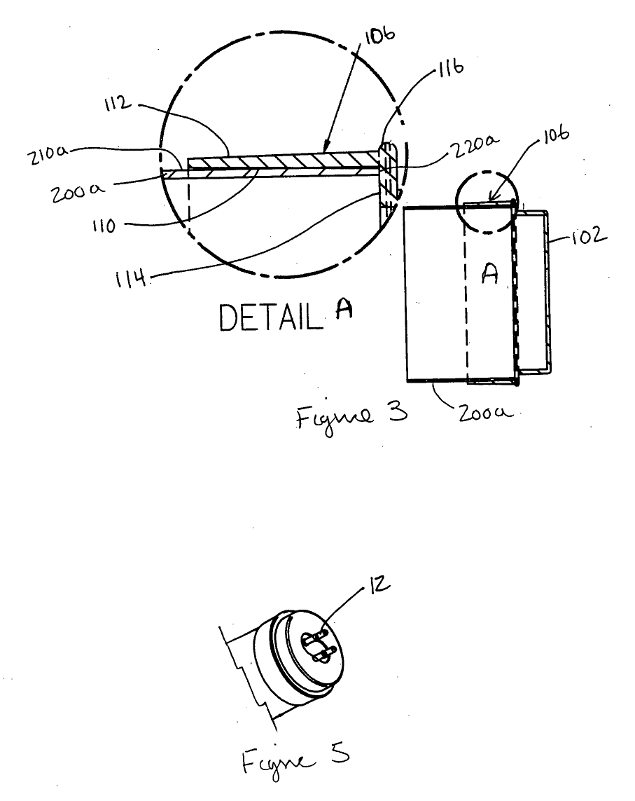

Referring now to the FIGS. 1-5, incandescent and fluorescent lamps 10 for use in lighting fixtures are delicate bulbs that when broken have a tendency to shatter. To protect the user and safely contain broken pieces, an elongated tube guard 20 is fitted over the lamp 10. The lamp 10 is suspended within the tube guard 20 such that the sides of the lamp 10 will not touch the interior of the tube guard 20. To hold and suspend the lamp 10 within the tube guard 20, an end cap 100 is placed at either end of the lamp 10. The end cap 100 is designed to fit at least two differently diameter tube guards. The benefit of manufacturing two differently diameter tube guards, is that during packaging and shipping the tube guards, the smaller diameter tube guard can slide within the larger diameter tube guard such that the space required to ship the tube guards is reduced dramatically.

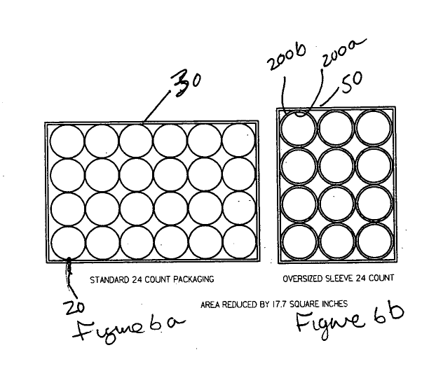

As illustrated in FIG. 6a, the prior art shipping container 30 includes a standard 24 count prior art tube guards 20. The space is reduced dramatically to the present invention container 50 (FIG. 6b), by including two differently diameter tube guards 200a and 200b, which have diameters that permit the smaller diameter tube guard 200a to slide within the larger diameter tube guard 200b. Therefore, the number of tube guards (24 count) shipped is the same but the area of the arrangement of tube guards is reduced. Moreover, the larger diameter tube guard 200b may be the standard sized tube guard manufactured today, to permit the use of existing tube guards.

Continuing to refer to FIGS. 1-5, the end cap 100 includes a base 102, which includes an aperture 104 for accommodating the electrical terminals 12 defined on the fluorescent lamp 10. The end cap 100 includes an annular wall 106 extending away from the base 102. The annular wall 106 has an internal periphery portion 110 and an external periphery portion 112. The annular wall 106 includes at an intermediate position, an inwardly protruding annular ledge 114 and an externally protruding annular ledge 116.

As illustrated in FIG. 3, the end cap 100 receives the end of a tube guard. In this illustration, the tube guard 200a includes a smaller diameter than the other tube guard 200b. The tube guard 200a frictionally fits within the end cap 100, such that the internal periphery portion 110 of the end cap 100 frictionally engages an external periphery 210a of the tube guard 200a. The tube guard 200a is pushed into the end cap 100, until the edge 220a of the tube guard 200a engages the inwardly protruding annular ledge 114.

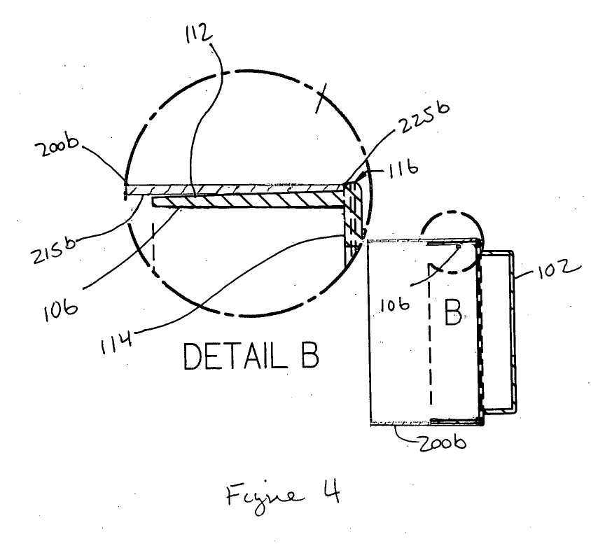

As illustrated in FIG. 4, the end cap 100 is also able to receive the end of the second tube guard 200b with the larger diameter. Similarly, the tube guard 200b frictionally fits onto the end cap 100, such that the external periphery portion 112 of the end cap 100 frictionally engages an internal periphery 215b of the tube guard 200b. The tube guard 200b is pushed onto the end cap 100, until the edge 225b of the tube guard 200b engages the externally protruding annular ledge 116.

The end cap 100 includes an annular wall 106 that is tapered on both sides to maintain a strong frictional engagement with the tube guards 200a and 200b.

Once end caps are placed on the tube guard, the electrical terminals 12 of the fluorescent lamp 100 will extend through the apertures 104 on both end caps 100. The fluorescent lamp 10 will then be fixed in place, such that its exterior will not come into contact with the interior of the tube guard surrounding.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred.

We claim:

1. An end cap for use with at least two differently diameter tube guards, said two differently diameter tube guards for use with a fluorescent lamp, said end cap comprising:
a base having an aperture for accommodating electrical terminals defined on the fluorescent lamp;
an internal periphery portion for frictional engagement with an external periphery of an end of one of said two differently diameter tube guards; and
an external periphery portion for frictional engagement with an internal periphery of an end of the other one of said two differently diameter tube guards.

2. The end cap of claim 1, wherein the internal periphery portion of said end cap is tapered to maintain the frictional engagement with said external periphery of said end of said one of said two differently diameter tube guards.

3. The end cap of claim 2, wherein the end cap further includes an inwardly protruding annular ledge to impinge upon said end of said one of said two differently diameter tube guards.

4. The end cap of claim 1, where the external periphery portion of said end cap is tapered to maintain the frictional engagement with said internal periphery of said end of said other one of said two differently diameter tube guards.

5. The end cap of claim 4, wherein the end cap further includes an externally protruding annular ledge to impinge upon said end of said other one of said two differently diameter tube guards.

6. The end cap of claim 1, wherein the at least two differently diameter tube guards includes a first tube guard with a first diameter that is smaller than a second tube guard with a second diameter such that the first tube guard is able to fit within the second tube guard.

7. An end cap for use with a first tube guard, said first tube guard for use with a fluorescent lamp, said end cap comprising:
a base having an aperture for accommodating electrical terminals defined on the fluorescent lamp;
an external periphery portion for frictional engagement with an internal periphery of an end of said first tube guard; and
the external periphery portion of said end cap is tapered to maintain the frictional engagement with said internal periphery of said end of said first tube guard.

8. The end cap of claim 7, wherein the end cap further includes an externally protruding annular ledge to impinge upon said end of said first tube guard.

9. The end cap of claim 7, wherein the end cap further includes an internal periphery portion for frictional engagement with an external periphery of an end of a second tube guard having a diameter smaller than a diameter defined by said first tube guard; and
the internal periphery portion of said end cap is tapered to maintain the frictional engagement with said external periphery of said end of said second tube guard.

10. The end cap of claim 9, wherein the end cap further includes an internally protruding annular ledge to impinge upon said end of said second tube guard.

11. An arrangement for compactly packaging elongated tube guards, each tube guard used in assembling a fluorescent lamp assembly, comprising:
a first set of elongated tube guards having a first diameter and a second set of elongated tube guards having a second diameter, wherein the second diameter is smaller than the first diameter, the second set of elongated tube guards arranged within the first set of elongated tube and the first set of elongated tube guards being stacked such that the arrangement of packaged elongated tube guards is minimized.
